(19) United States
(12) Patent Application Publication
(10) Pub. No.: US 2009/0141282 A1
(43) Pub. Date: Jun. 4, 2009

(54) CONCENTRATION MEASURING STRUCTURE CAPABLE OF REDUCING THE EFFECT OF ENVIRONMENTAL TEMPERATURE

(76) Inventor: YUNG-LIEH CHIEN, Chupei (TW)

Correspondence Address: G. LINK CO., LTD., 3550 BELL ROAD, MINOOKA, IL, 60447, US

(21) Appl. No.: 11/949,946

(22) Filed: Dec. 4, 2007

(51) Int. Cl. G01N 21/00

(52) U.S. Cl. 356/440

(57) ABSTRACT

A concentration measuring structure capable of reducing the effect of environmental temperature features the arrangement of a concentration detector in the fluid communication space of a fluid circulating device in a fuel cell system to let the fluids in the concentration detector and the fuel cell achieve equal temperature, thereby reducing measurement error caused by the effect of environmental temperature.

### FIELD OF THE INVENTION

The present invention relates to a concentration measuring structure, particularly a concentration measuring device capable of reducing the effect of environmental temperature and determining fluid concentration by detecting change in optical properties of the fluid.

### BACKGROUND OF THE INVENTION

Conventional fluid measuring devices perform measurement based on the physical characteristics of fluid, such as concentration, density or quantity. General fluid measuring devices are sizable and complex in structure, and hence are more costly. However there is increasingly market demand for small-size and low-cost products. Take the example of fuel cell system, its applications in portable electronic devices are gaining grounds. In a fuel cell system that uses hydrogen-rich fuel (e.g. methanol) and oxygen fuel to undergo electrochemical reaction and output power, it is necessary for users to know when to replenish the fuel when fluid concentration or level becomes low. Thus it is necessary to detect the fluid fuel level and volume in the fuel container. Such detection work is typically achieved through expensive metering sensor, which is rather uneconomical when used extensively in portable electrical products.

The core of conventional fuel cells lies in the use of hydrogen-rich fluid (e.g. methanol) and oxygen fluid to undergo electrochemical reaction. In the applications of such fuel cells, it is necessary for users to know when to replenish the fuel when fluid concentration or level becomes low. Detection of fluid concentration in the fuel container is typically achieved through expensive metering sensor, which is rather uneconomical when used extensively in portable electrical products. In addition, in the electrochemical reaction of a fuel cell system, variations of fuel temperature along with the progression of the electrochemical reaction might result in measurement errors.

In light of the drawbacks of conventional concentration measuring devices, the inventor aims to develop a concentration measuring structure that meets the current demands.

### SUMMARY OF THE INVENTION

The primary object of the invention is to provide a concentration measuring structure capable of reducing the effect of environmental temperature by equaling the fluid temperature in the concentration detector and the fuel cell so as to reduce measurement error caused by temperature difference.

Another object of the invention is to provide a concentration measuring structure capable of reducing the effect of environmental temperature and featuring a flow channel which helps reduce the generation of fluid bubbles and helps eliminate the aggregation of fluid bubbles.

A further object of the invention is to provide a concentration measuring structure capable of reducing the effect of environmental temperature and featuring light-condensing element to adjust the light path and thereby cut down light loss.

To achieve the aforesaid objects, the present invention provides a concentration measuring structure capable of reducing the effect of environmental temperature, comprising a casing in hollow configuration and having an accommodation space, the accommodation space having thereon two opposing bumps; a fluid inlet orifice being configured on a side surface of the casing such that the accommodation space communicates with the exterior; a fluid outlet orifice configured on the other side surface of the casing such that the accommodation space communicates with the exterior and configured at a horizontal level higher than the fluid inlet orifice; a light source device disposed on one of the bumps; and a light sensing device disposed on the other bump and comprising a light sensor capable of converting optical signal into electric signal. The electric signal is an electrical signal output by the light sensor corresponding to the intensity of the optical signal under the illumination of light source. As such, the fluid temperature in concentration detector and in fuel cell reaches an equal state to prevent measurement error caused by temperature difference.

The objects, features and effects of the invention are described in detail below with embodiments in reference to the accompanying drawings.

### BRIEF DESCRIPTION OF THE DRAWINGS

FIG. 1 is an exploded view of the concentration measuring structure capable of reducing the effect of environmental temperature according to the invention;

FIG. 2 is an assembly view of the concentration measuring structure capable of reducing the effect of environmental temperature according to the invention;

FIG. 3 is a sectional view along 3-3 in FIG. 2; and

FIG. 4 is a sectional view along 404 in FIG. 2.

### DETAILED DESCRIPTION OF THE INVENTION

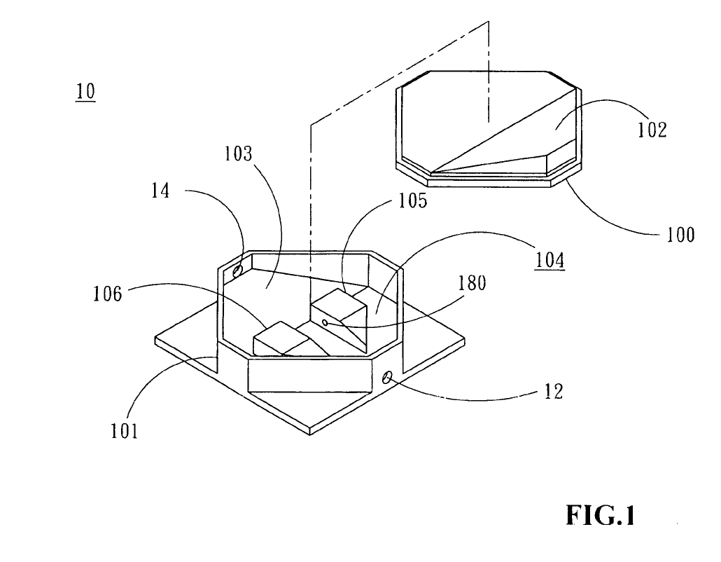

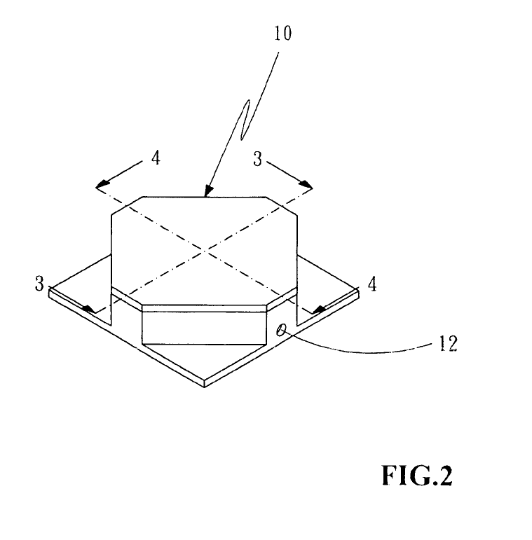

FIG. 1 is an exploded view of the concentration measuring structure capable of reducing the effect of environmental temperature according to the invention. FIG. 2 is an assembly view of the concentration measuring structure capable of reducing the effect of environmental temperature according to the invention. As shown, the concentration measuring structure capable of reducing the effect of environmental temperature comprises a casing (10) provided with a fluid inlet orifice (12), a fluid outlet orifice (14), a light source device (16), and a light sensing device (18) thereon. An embodiment of the invention is described in detail below.

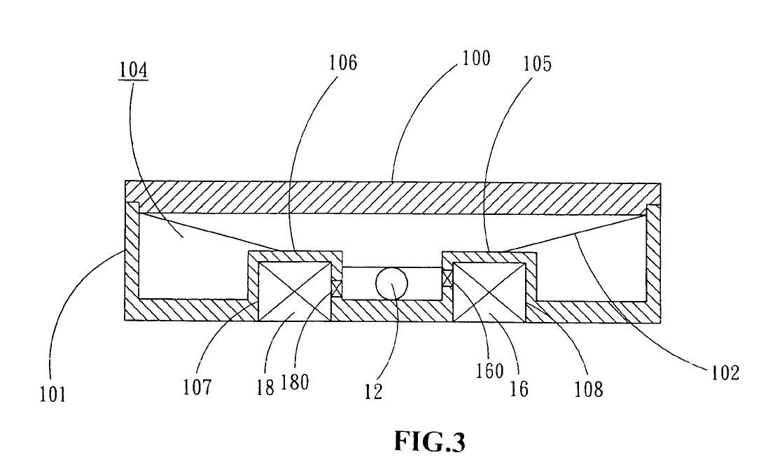

The casing (10) consists of a lid body (100) and a box body (101). The lid body (100) and the box body (101) respectively have a first beveled guide face (102) and a second beveled guide face (103), the two beveled guide faces having the same gradient. The casing (10) has a hollow configuration with an accommodation space (104) for accommodating fluid. The accommodation space (104) is provided thereon two opposing bumps, being the first bump (105) and the second bump (106) respectively. The interior of the two bumps (105, 106) is respectively provided with a groove, being the first groove (107) and the second groove (108). The two grooves further communicate with the outer surface at the bottom of the box body (101) (as shown in FIG. 3).

The fluid inlet orifice (12) is configured on one side surface of the box body (101) and allows the accommodation space (104) to communicate with the exterior.

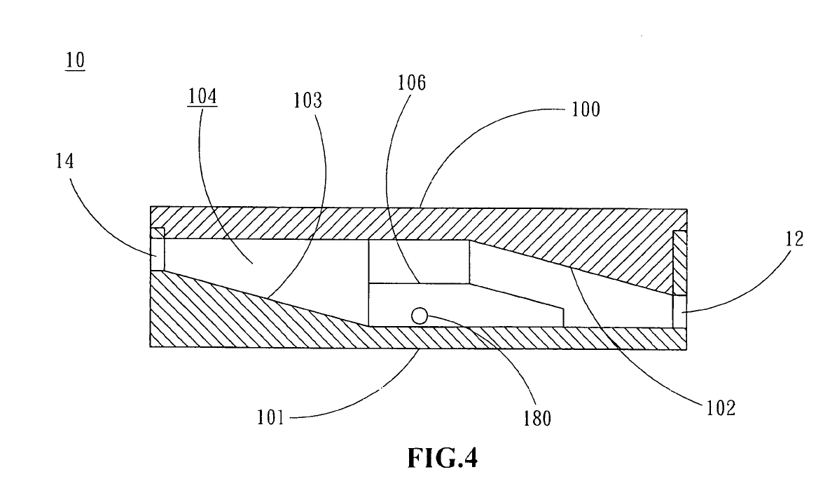

The fluid outlet orifice (14) is configured on the other side surface of the box body (101) and allows the accommodation space (104) to communicate with the exterior. The fluid outlet orifice (14) is positioned at a horizontal level higher than the fluid inlet orifice (12) (as shown in FIG. 4).

The light source device (16) is disposed on the first bump (105), whereas the light sensing device (18) is disposed on the second bump (106). The light sensing device (18) comprises a light sensor (180) capable of converting optical signal into electric signal. The electric signal is an electrical signal output by the light sensor (180) corresponding to the intensity of the optical signal under the illumination of light source.

After the lid body (100) overlays the box body (101), fluid can enter the accommodation space (104) inside the casing (10) from the fluid inlet orifice (12) and be discharged from the fluid outlet orifice (14). Because the horizontal level of the fluid outlet orifice (14) is higher than that of the fluid inlet orifice (12), the first bump (105) and the second bump (106) are most likely completely immersed in the fluid, which could reduce the effect of environmental temperature. In addition, the first beveled guide face (102) and the second beveled guide face (103) allow the smooth flow of fluid to prevent the generation of bubbles.

The light source device (16) selects the source of light from infrared light, visible light or single-wavelength light for the production of a light beam. The light source device (16) can be coupled with a light-condensing element (160) arranged on the same bump (105) as the light source device (16). The light-condensing element (160) turns the divergent light beam generated by the light source device (16) into parallel light beam to converge the energy of light beam. The parallel light beam can penetrate the fluid in the accommodation space (104) of the casing (10) where part of the light beam energy is absorbed by the fluid while the remaining energy is incident on the light sensor (180) of the light sensing device (18), such as a photosensitive element which would convert the optical signal received by the light sensor (180) into a corresponding electric signal. Finally a computing device (not shown in the figure), such as a microprocessor is used to compute based on the electric signal to obtain the concentration of fluid in the accommodation space (104).

The part of the accommodation space (104) of the casing (10) corresponding to the light beam emitted by the light source device (16) and another part where the light sensor (180) receives the light beam are light transmittable, while the remaining parts of the casing (10) are non-light transmittable, hence preventing external light from interfering with the optical signals received by the light sensor (180).

To sum up, the concentration measuring structure capable of reducing the effect of environmental temperature provided by the invention employs the arrangement of a concentration detector in the fluid communication space to reduce the measurement error caused by the effect of environmental temperature. Thus the invention possesses an inventive step and meets the essential criteria for patent application.

The present invention has been described in detail. However the description presents only a preferred embodiment of the invention, hence should not be construed as a limitation on the actual applicable scope of the invention, and as such, all modifications and alterations without departing from the spirits of the invention and appended claims shall remain within the protected scope and claims of the invention.

What is claimed is:

1. A concentration measuring structure capable of reducing the effect of environmental temperature, comprising:
a casing in hollow configuration and having an accommodation space, the accommodation space having two opposing bumps thereon;
a fluid inlet orifice configured on one side surface of the casing and allowing the accommodation space to communicate with the exterior;
a fluid outlet orifice configured on the other side surface of the casing and allowing the accommodation space to communicate with the exterior, the fluid outlet orifice being positioned at a horizontal level higher than the fluid inlet orifice; a light source device disposed on one of the bumps; and
a light sensing device disposed on the other bump, the light sensing device comprising a light sensor for converting an optical signal into an electric signal, the electric signal being an electrical signal output by the light sensor corresponding to the intensity of the optical signal under the illumination of light source.

2. The concentration measuring structure according to claim 1, wherein the casing consists of a lid body and a box body.

3. The concentration measuring structure according to claim 2, wherein the lid body has a first beveled guide face thereon.

4. The concentration measuring structure according to claim 3, wherein the box body has a second beveled guide face thereon.

5. The concentration measuring structure according to claim 4, wherein the first beveled guide face and the second beveled guide face have the same gradient.

6. The concentration measuring structure according to claim 1, wherein the interior of the two bumps has respectively a groove which further communicates with the external surface of the casing.

7. The concentration measuring structure according to claim 1, wherein the light sensor outputs a current value corresponding to the fluid transmittance of light beam emitted by the light source device when it passes through the accommodation space.

8. The concentration measuring structure according to claim 1, wherein the part of the casing corresponding to the light beam emitted by the light source device and another part where the light sensor receives the light beam are light transmittable while the remaining parts of the casing are non-light transmittable.

9. The concentration measuring structure according to claim 1, wherein the light source output by the light source device is infrared light, visible light or single-wavelength light.

10. The concentration measuring structure according to claim 9, wherein the light source device is coupled with a light-condensing element.

11. The concentration measuring structure according to claim 1, wherein the light sensor is a photosensitive element.
